(19) United States
(12) Patent Application Publication
(10) Pub. No.: US 2004/0263663 A1
(43) Pub. Date: Dec. 30, 2004

(54) Digital camera image controller apparatus for a mobile phone

(75) Inventors: Charng-Long Lee, Hsinchu City (TW); Chih-Kai Hsu, Hsinchu City (TW)

Correspondence Address: BACON & THOMAS, PLLC, 625 SLATERS LANE, FOURTH FLOOR, ALEXANDRIA, VA, 22314

(73) Assignee: Sunplus Technology Co., Ltd., Hsinchu (TW)

(21) Appl. No.: 10/811,861

(22) Filed: Mar. 30, 2004

(30) Foreign Application Priority Data
Jun. 25, 2003 (TW) 092117297

(51) Int. Cl. H04N 5/222; H04N 9/74; H04N 5/225; H04N 3/14; H04N 5/335; H04N 9/04; H04N 9/083

(52) U.S. Cl. 348/333.11; 348/376; 348/273

(57) ABSTRACT

A digital camera image controller apparatus for a mobile phone is disclosed, which uses a sensing module to collect optical signal of an image and produce RGB (red, green, blue) image signal from the optical signal, and an image controller to receive the RGB image signal and accordingly produce a preview signal of the image to an LCD module. Also, the image controller outputs compressed or non-compressed image signal to a baseband processor. In addition, the image controller includes chromatic aberration interpolator and an RGB-to-YUV converter provided by a typical camera module. Therefore, the inventive camera module can include a sensing module simply having lens and sensor, thus avoiding defects caused by using the typical camera module.

### BACKGROUND OF THE INVENTION

1. Field of the Invention

The present invention relates to digital camera image controller and, more particularly, to a digital camera controller apparatus adapted for a mobile phone.

2. Description of Related Art

Upon prospering electronic technology development, current mobile handset can provide voice communication and even other various functions. For example, a camera module is increasingly installed on a mobile handset such that the mobile handset can take a picture and real-time transmit the picture through wireless communications. FIG. 1 shows a configuration of a mobile handset with a camera module 11. As shown in FIG. 1, the camera module 11 includes lens 111, sensor 112, color interpolation device 113 and RGB-to-YUV converter 114. The lens 111 collects optical signal of image. The sensor 112 senses the optical signal and converts it into an electrical signal. The sensor 112 is formed by pixels in an array arrangement to sense color image. Each pixel can sense red (R), green (G) or blue (B) color. The array arrangement is interlaced by one line with RGRG . . . and the other line with GBGB . . . , as shown in FIG. 2. The color interpolation device 113 can interpolate missing color such that complete RGB information for each pixel is re-built. The complete RGB information is converted by the RGB-to-YUV converter 114 into data with YUV format. The YUV-format image data is subsequently processed by the baseband processor 12 of a mobile handset and thus extracted image is displayed on LCD screen 13.

In the cited configuration, the baseband processor 12 is responsible for compressing and decompressing image, controlling image processing to the LCD screen 13 and the like, for example. Therefore, the baseband processor 12 loads heavy on operation and further causes a very slow speed at image preview on the LCD screen 13. Accordingly, as shown in FIG. 3, a dedicated image compression controller 31 is added to lighten the load of the baseband processor 12. However, this still cannot avoid the problem of very slow preview speed. Another solution is given by using a display controller 41 including image compression engine 411 (e.g., JPEG codec), image conversion interface 412 and buffer 413, to improve the performance of a digital camera, which can lighten the load of the baseband processor 12 and speed up the speed at image preview.

However, as cited, all prior configurations require using the camera module 11. This includes following defects: (1) expensive price, which is caused by complicated hardware to perform operations like color interpolation and color conversion; (2) less flexibility on color correction; and (3) lower reliability due to complicated processes.

Therefore, it is desirable to provide an improved digital camera image controller apparatus adapted for a mobile phone to mitigate and/or obviate the aforementioned problems.

### SUMMARY OF THE INVENTION

The object of the present invention is to provide a digital camera image controller apparatus for a mobile phone for eliminating prior defects.

To achieve the object, the digital camera image controller apparatus for a mobile phone of the present invention includes: an LCD module as a display for the mobile phone in order to display information for communication; a baseband processor connected to circuit of the mobile phone in order to perform required communication processing; a sensing module to sense an optical signal of an external image and thus produce an RGB image signal; and an image controller. The image controller includes: a chromatic aberration interpolator to interpolate chromatic aberration for each pixel of the RGB image signal produced by the sensing module, such that RGB image signal with complete color information is obtained; an RGB-to-YUV converter to convert the RGB image signal with complete color information into a YUV image signal; a compression engine to compress or decompress the YUV image signal; a buffer to temporarily store the RGB image signal with complete color information and the YUV image signal compressed by the compression engine; and a YUV-to-RGB converter to convert the YUV image signal after decompressed by the compression engine into the RGB image signal with complete color information for displaying on the LCD module. The RGB image signal temporarily stored in the buffer can directly be displayed on the LCD module. The YUV image signal compressed and temporarily stored in the buffer can alternatively be output to the baseband processor for next processing.

Other objects, advantages, and novel features of the invention will become more apparent from the following detailed description when taken in conjunction with the accompanying drawings.

### BRIEF DESCRIPTION OF THE DRAWINGS

FIG. 1 is a diagram of a typical configuration of mobile handset with camera module;

FIG. 2 is a view of a sensor with array arranged pixels pattern;

FIG. 3 is a diagram of another typical configuration of mobile handset with camera module;

FIG. 4 is a diagram of a further typical configuration of mobile handset with camera module;

FIG. 5 is a configuration diagram of a digital camera image controller apparatus for a mobile phone according to the invention;

FIG. 6 is a configuration diagram of an image controller of the apparatus of FIG. 5 according to the invention; and

FIG. 7 is another configuration diagram of an image controller of the apparatus of FIG. 5 according to the invention.

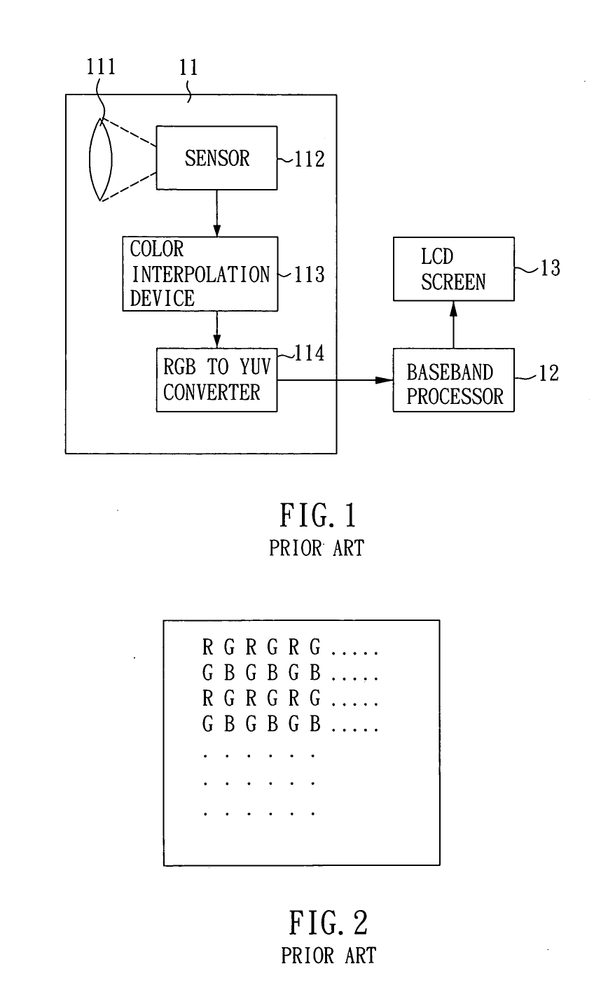

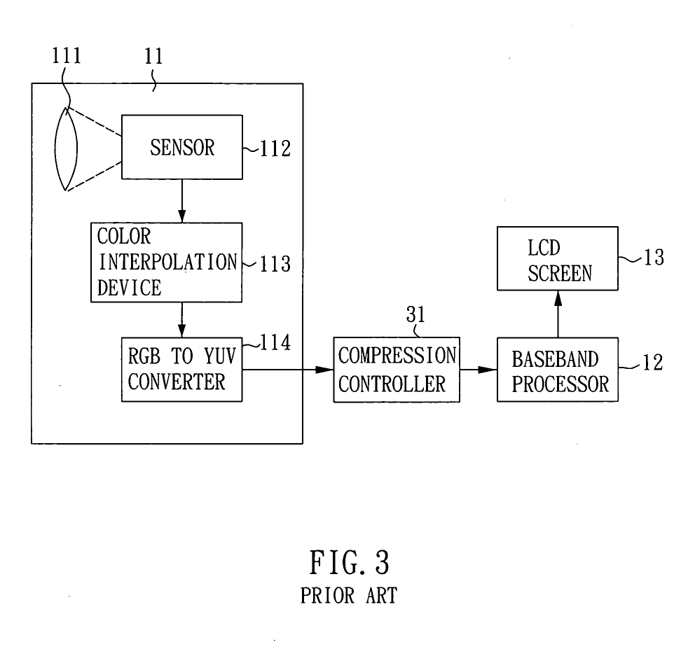

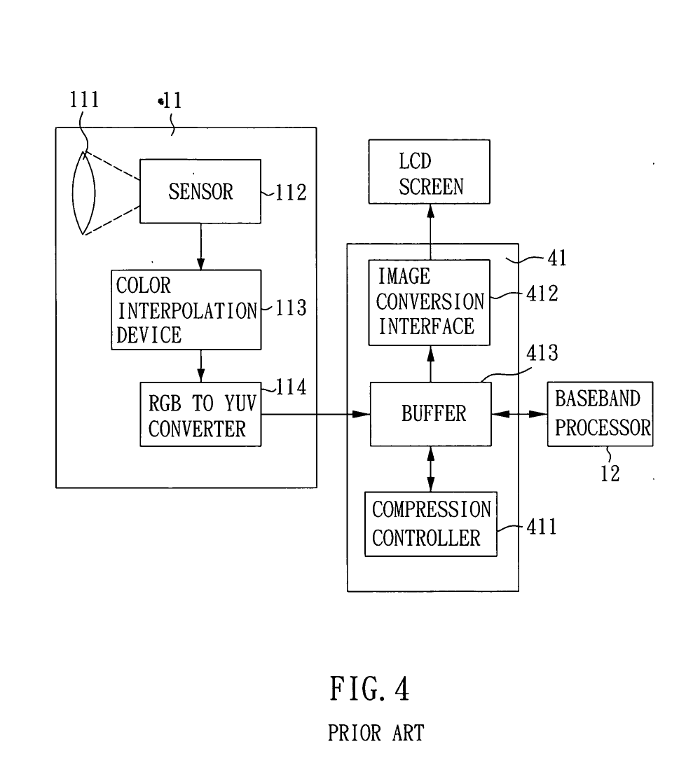

### DETAILED DESCRIPTION OF THE PREFERRED EMBODIMENT

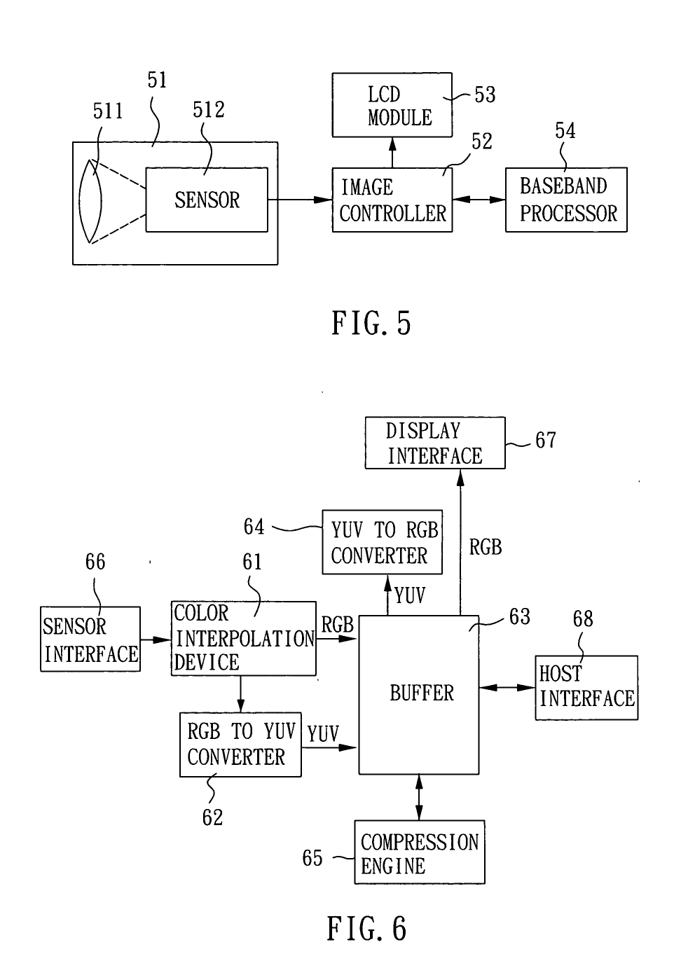

With reference to FIG. 5, there is shown a configuration of an inventive digital camera image controller apparatus for a mobile phone. In FIG. 5, the apparatus includes a sensing module 51, an image controller 52, an LCD module 53 and a baseband processor 54. The baseband process 54, as a processing means for a typical mobile phone, connects to circuit of the typical mobile phone for required communication processing. The LCD module 53, as a display means for the typical mobile phone, displays information for communication.

The cited sensing module 51 includes a lens 5 1 1 and a sensor 512. The lens 511 collects an optical signal of an image. The optical signal is sensed by the sensor 512 to produce an RGB image signal with Bayer pattern, for example. The image controller 52 receives the RGB image signal to accordingly produce a preview signal of the image to the LCD module 53 and outputs compressed or non-compressed image signal to the baseband processor 54.

FIG. 6 shows a configuration of the image controller 52 of FIG. 5. In FIG. 6, the image controller 52 essentially includes a color interpolation device 61, an RGB-to-YUV converter 62, a buffer 63, a YUV-to-RGB converter 64, a compression engine 65, a sensor interface 66 connected to the sensing module 51, a display interface 67 connected to the LCD module 53 and a host interface 68 connected with the baseband processor 54. The sensor interface 66 receives the RGB image signal with Bayer pattern from the sensing module 51. The color interpolation device 61 interpolates color for each pixel of the RGB image signal received and thus obtains an RGB image signal with complete color information.

The RGB image signal with complete color information can directly be stored in the buffer 63 and immediately output to the LCD module 53 through the image interface 67 for displaying, or is sent to the baseband processor 54 through the host interface 68 for next processing. In addition, the RGB image signal with complete color information can be converted by the RGB-to-YUV converter 62 into a YUV image signal. The YUV image signal after compressed by the compression engine 65 such as JPEG Codec is stored in the buffer 63. The YUV image signal compressed is sent to the baseband processor 54 through the host interface 68 for further processing. Compressed image data received from the baseband processor 54 by the host interface 68 needs to be temporarily stored in the buffer 63 and then decompressed as the YUV image signal by the compression engine 65. Thus, the YUV-to-RGB converter 64 can convert the YUV image signal as the RGB image signal for displaying on the LCD module 53 through the display interface 67. Further, when image data received from the baseband processor 63 by the host interface 68 is not compressed, it is temporarily stored in the buffer 63 and immediately displayed on the LCD module 53 through the display interface 67.

As cited, in such a configuration, since the image controller 52 includes the color interpolation device 61 and the RGB-to-YUV converter 62 typically provided by the camera module, the camera module is simplified to include only the sensing module 51 having the lens 511 and the sensor 512. Thus, defects caused by the prior camera module are prevented. Also, increasing adjustment flexibility to color images of different sensing modules is obtained because color interpolation and image signal conversion are performed in a same image controller 52.

In addition, in such a configuration, because the lens 511 and the sensor 512 are located in the sensing module 51 while the color interpolation device 61, the RGB-to-YUV converter 62 and the compression engine 65 are packed in the image controller 52, separate activation for operations can be controlled by the image controller 52 on needs. For example, the baseband processor 54 can directly display an image existing in a mobile phone through the image controller 52 without activating the camera's functions, i.e., the sensing module 51 and the devices 61, 62, 65 of the image controller 52 need not to be activated. Therefore, a feed-through operation mode capable of saving power is provided.

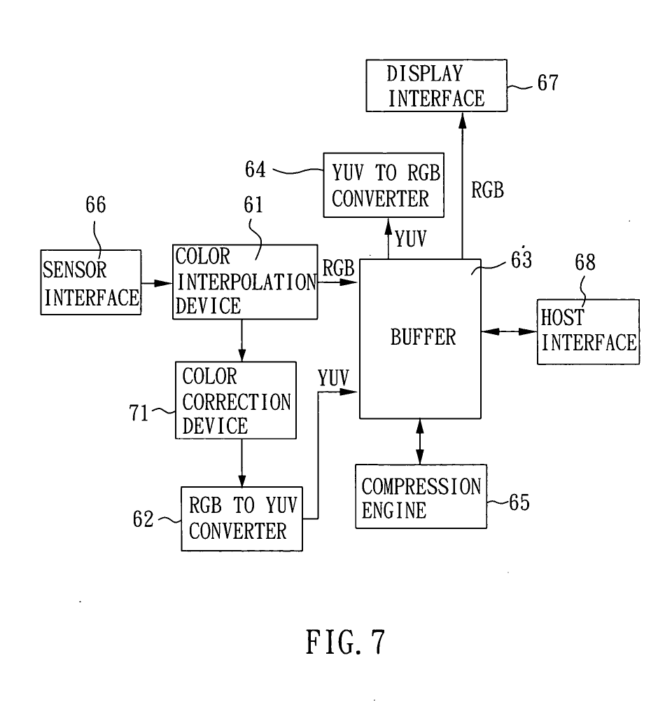

FIG. 7 shows another configuration of the image controller 52, which is similar to that shown in FIG. 6 except that, in between the color interpolation device 61 and RGB-to-YUV converter 62, there is a color correction device 71 to correct the nonlinear color response due the electronic sensor characteristics and different light sources. This color correction device is employed to get the correct color reproduction for the captured image, thereby avoiding the effect in that the color of resulting images may slightly deviate from the actual colors. However, this image controller 52 will still work similar as the one shown in FIG. 6.

Although the present invention has been explained in relation to its preferred embodiment, it is to be understood that many other possible modifications and variations can be made without departing from the spirit and scope of the invention as hereinafter claimed.

What is claimed is:

1. A digital camera image controller apparatus for a mobile phone, comprising:
an LCD module, as a display means of the mobile phone, to display information for communication;
a baseband processor, connected to circuit of the mobile phone in order to perform required communication processing;
a sensing module, to sense optical signal of an external image and accordingly produce an RGB image signal; and
an image controller, having:
a color interpolation device, to interpolate color for each pixel of the RGB image signal produced by the sensing module and thus obtain an interpolated RGB image signal with complete color information;
an RGB-to-YUV converter, to convert the interpolated RGB image signal into a YUV image signal;
a YUV-to-RGB converter, to convert the YUV image signal into the interpolated RGB image signal;
a compression engine, to compress or decompress the YUV image signal in order to produce a compressed or decompressed YUV image signal; and
a buffer, to temporarily store the interpolated RGB image signal and the compressed YUV image signal,
wherein the interpolated RGB image signal in the buffer is able to directly display on the LCD module, the compressed YUV image signal in the buffer is sent to the baseband processor for further processing or to the compression engine for decompression and subsequently the YUV-to-RGB converter converts the decompressed YUV image signal into the interpolated RGB image signal for displaying on the LCD module.

2. The apparatus as claimed in claim 1, wherein the sensing module includes a lens and a sensor respectively to collect optical signal of the external image and sense the optical signal for producing the RGB image signal.

3. The apparatus as claimed in claim 1, wherein the compression engine is a JEEG codec.

4. The apparatus as claimed in claim 1, further comprising a sensor interface connected to the sensing module.

5. The apparatus as claimed in claim 1, further comprising a display interface connected to the LCD module.

6. The apparatus as claimed in claim 1, further comprising a host interface connected to the baseband processor.

7. The apparatus as claimed in claim 1, wherein, in operating, both the interpolated RGB image signal and the compressed YUV image signal temporarily stored in the buffer come from the sensing module.

8. The apparatus as claimed in claim 1, wherein, in operating, both the interpolated RGB image signal and the compressed YUV image signal temporarily stored in the buffer come from the baseband processor.

9. The apparatus as claimed in claim 1, wherein, in operating, the baseband processor directly displays an image, which exists in the mobile phone, on the LCD module through the image controller, without activating the color interpolation device, RGB-to-YUV converter and compression engine of the image controller and the sensing module.

10. The apparatus as claimed in claim 1, wherein, the image controller further comprises a color correction device arranged in between the color interpolation device and RGB-to-YUV converter to correct nonlinear color response due the electronic sensor characteristics and different light sources.
